(19) United States
(12) Patent Application Publication
(10) Pub. No.: US 2003/0037257 A1
(43) Pub. Date: Feb. 20, 2003

(54) Debugging device

(76) Inventor: Wen Hsin Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/219,312

(22) Filed: Aug. 16, 2002

(30) Foreign Application Priority Data
Aug. 17, 2001 (TW) 90120190

(51) Int. Cl. H04L 9/00

(52) U.S. Cl. 713/200

(57) ABSTRACT

A debugging device for detecting or collecting data of a target system for analysis and debugging comprises a user interface, which is used to set triggering data to be recorded and for transfer them to a translator of triggering events. The translator gives a code or index to each triggering event and transfers it to control logic after logic simplification. The control logic sets the simplified data into a programmable comparator, which receives an input signal from the target system to check whether the input signal conforms to a previously set triggering condition. A corresponding code or index of the input data is transferred to the control logic and stored. An analyzer of triggering events retrieves and restores the codes into previously set triggering events from the storage to detect and pick up execution states of the target system operating in a real environment, and then analyzes and debugs them. Therefore, bugs or errors in systems can easily be detected and debugged so as to be quickly corrected so that system performance is improved.

### FIELD OF THE INVENTION

The present invention relates to a debugging device used to check and determine fault positions and, more particularly, to a debugging device capable of monitoring or recording a quantity of data such as execution states of a computer target system (e.g., a microprocessor) in the real-time mode and analyzing system performance and error states according to the data.

### BACKGROUND OF THE INVENTION

For some information processing systems, when the system performs operations:, large quantities of information like data and addresses are transmitted to and from the CPU. If there are logic errors or incomplete operations in a system program, bugs will occur during operation of program and the system may easily crash, hence affecting operational performance. In order to improve and avoid crashes of the system, it is usually necessary to check if there are any bugs or faults in the system program and determine the fault position, thereby achieving the object of debugging.

Presently, there are some tools for system design. However, there are relatively no improvements in debugging of final finished products. The main difference lies in that the object is more explicit when designing, but bugs are not known when debugging. Furthermore, with a finished product, the system has been integrated so the complexity has been greatly increased and users cannot effective perform debugging. Sometimes, users are forced to use a watchdog to monitor an event occurring during a prescribed time in the system at some preset states. If it is a normal event occurring periodically, the system will be guided to process this event; if it is an abnormal event, the system is generally reset. However, this kind of watchdog can merely observe but cannot thoroughly solve the problem of the system crash.

Besides, for embedded microprocessors, conventional tools for program debugging include apparatuses like oscilloscopes or logic analyzers. Take these instruments for example, they can only perform their functions at situations of short time duration and with problems that can be easily duplicated. Only when the locations of the bugs are roughly known can the triggering conditions be set, and then the bugs can be observed and solved with the help of the instruments. However, if the bug only occurs occasionally and is difficult to duplicate, it is very difficult to observe and solve the bug with the traditional instruments.

Accordingly, the present invention provides a debugging device, which does not affect the operation of a real-time system and can record operational states of the system.

### SUMMARY OF THE INVENTION

An object of the present invention is to provide a debugging device capable of recording and analyzing operational states of a target system that is operating in a real-time mode for a long time so as to analyze system performance and determine the type or location of a bug in a program according to the recorded information.

Another object of the present invention is to provide a debugging device, which transforms information such as addresses, data, and I/O's into a list of codes or indexes to be reviewed and edited by users. If the conditions are triggered when a target system operates, the required recording capacity and transmission bandwidth can be greatly reduced by using the corresponding codes or indexes. Therefore, a large quantity of information can be recorded more efficiently.

To achieve these and other objects, the present invention comprises a user interface, which is used to set triggering data to be recorded and transfer them to a translator for a triggering event. The translator of the triggering event gives a code or index to each triggering event and transfers it to control logic after logical simplification. The control logic sets the simplified data into a programmable comparator, which receives an input signal from a target system to check whether the input signal conforms to a previously set triggering condition. A corresponding code or index of input data conforming to a triggering condition is transferred to the control logic and is stored together with the timing information. An analyzer of triggering events reads out data from the storage to retrieve the code or index and restore the code or index into a previously set triggering event, and then users can easily review, analyze, and debug the target system.

The various objects and advantages of the present invention will be more readily understood from the following detailed description when read in conjunction with the drawings, in which:

### BRIEF DESCRIPTION OF THE DRAWINGS

FIG. 1 is a block diagram of the debugging device according to an embodiment of the present invention;

FIG. 2 is block diagram of the debugging device according to another embodiment of the present invention; and

FIG. 3 is a block diagram of the present invention with all modules integrated together according to an embodiment of the present invention.

### DETAILED DESCRIPTION OF THE PREFERRED EMBODIMENTS

The debugging device of the present invention is connected to a host computer and is connected to a target system to detect and store codes or indexes of conditional information triggered when the target system operates according to indexes transformed from triggering conditions like addresses, data, and I/O's previously set by users, thereby facilitating analysis and debugging operations. Therefore, the required recording capacity and transmission bandwidth can be greatly reduced to record a large quantity of information more efficiently.

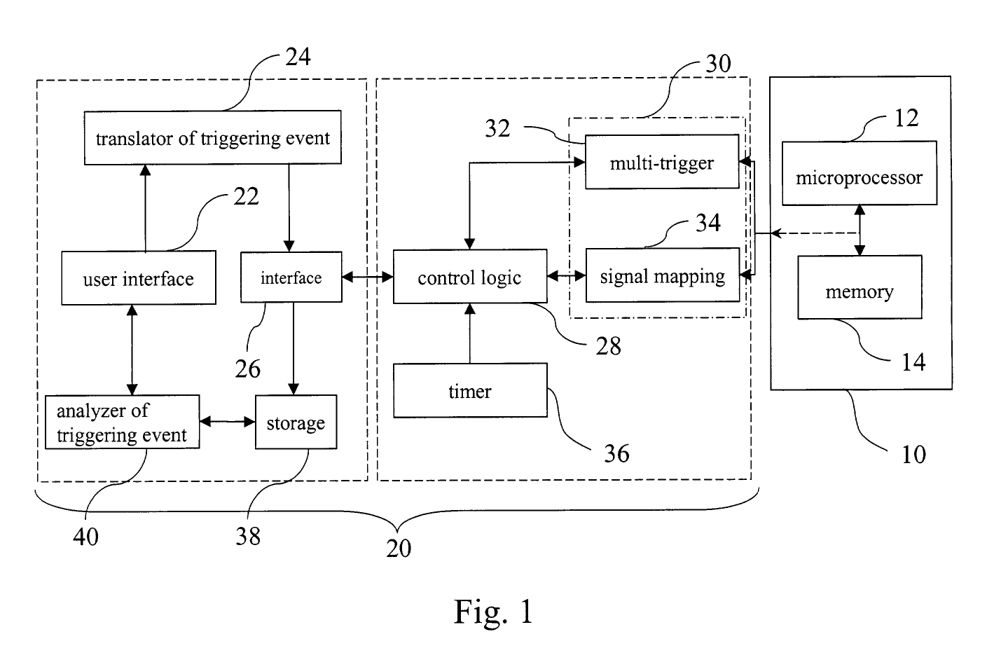

Referring to FIG. 1, which is a block diagram of the debugging device according to an embodiment of the present invention.

As shown in FIG. 1, the target system to be debugged is an application specific integrated circuit (ASIC) 10 with a built-in microprocessor 12. In this embodiment the target system to be debugged is an application specific integrated circuit (ASIC) 10 including an inbuilt microprocessor 12 and a memory 14. However, other types of target systems can also be easily debugged utilizing the debugging device of the present invention.

The programs for the target system 10 are stored in a memory 14. This type of system often crashes when the ASIC 10 is under bum-in tests. However, users generally do not know where the problem originates from. The ASIC 10 is thus connected to a debugging device 20 to record program flow for a certain period of time so as to help the user know practical operational situations of the ASIC 10 and narrow the range of investigation to solve the problem.

The debugging device 20 comprises a user interface 22 so that a user can easily review, edit, and set triggering conditions. The set conditions are all signals to be analyzed, which are recorded in lists. The signals can be combinations of addresses, data, and I/O's. The trigger data to be recorded are transferred to a translator of the triggering event 24. The program of the microprocessor 12 is compiled by a compiler to generate an object code, which is then linked by a linker to generate a machine code. Then entry addresses and exit addresses of all subroutines will be generated. These addresses are used as trigger points. Once it is detected that the microprocessor 12 accesses these addresses, users can know when the microprocessor 12 starts or finishes a certain subroutine of the program. Therefore, these entry and exit addresses can be inputted as triggering conditions through the user interface 22. A code or index is then given to each triggering condition. The translator of the triggering event 24 will transfer the triggering event to a control logic 28 via an interface 26 after logical simplification. The control logic 28 sets the simplified data from the translator of triggering event 24 into a programmable comparator 30 according to the transmission protocol. The programmable comparator 30 includes a multi-trigger 32 and a signal mapping 34. The programmable comparator 30 is connected to the ASIC 10 for receiving an input signal thereof to check whether the input signal conforms to a previously set triggering condition. The control logic 28 is also connected to a timer 36 to record the occurring time of event.

When the microprocessor 12 operates, any input signal conforming to the triggering events (i.e., the entry and exit addresses of the subroutines) will make the multi-trigger 32 in the programmable comparator 30 generate a signal with matching conditions to the control logic 28. Meanwhile, a signal outputted by the signal mapping 34 is a corresponding code of the triggering event. The code corresponding to the triggering event is outputted to the control logic 28, which sends all messages like the received matching signal and the code or index of the triggering event along with occurring time of the triggering event provided by the timer 36 back to the interface 26. The interface 26 then stores these message data into a storage 38. When the user wants to know the status of the microprocessor 12 and how the microprocessor 12 is trapped, he can use the analyzer of triggering event 40 connected to the user interface 22 to retrieve and restore data from the storage 38 through the user interface 22. The retrieved code or index is restored into an originally set triggering event for easily reviewing, debugging and analysis so as to help the user know whether the microprocessor 12 in the ASIC 10 is trapped in a specific subroutine, or there is an abnormal interrupt, or the program has led the microprocessor 12 to some undesired places, and so on. Moreover, the execution times and time duration of each subroutine can also be known through the timer 36, which are provided to the user as a basis for analyzing and improving the program.

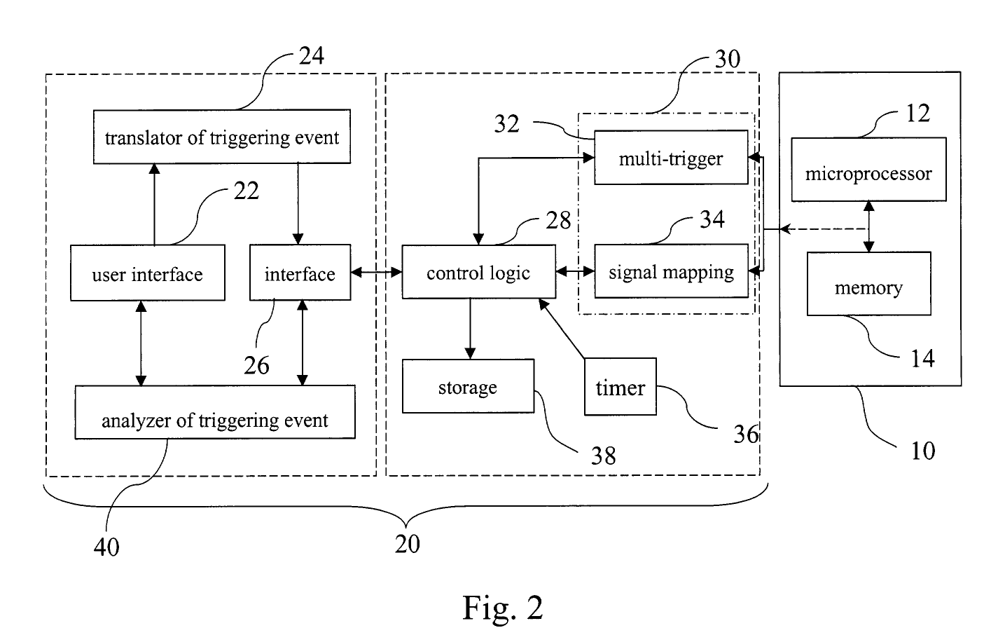

Refer to FIG. 2, which is a block diagram of the debugging device according to the second embodiment of the present invention;

In addition to being externally connected to the interface 26 and the analyzer of the triggering event 40, the storage 38 can also be directly connected to the control logic 28 in consideration of storage capacity and bandwidth requirements, as shown in FIG. 2. The control logic 28 can directly store all received messages and timing information into the storage 38 without transmission via the interface 26. Meanwhile, when a user performs analysis and debugging via the user interface 22, the analyzer of triggering events 40 needs to retrieve and restore data from the storage 38 via the interface 26 and the control logic 28 for debugging and analysis.

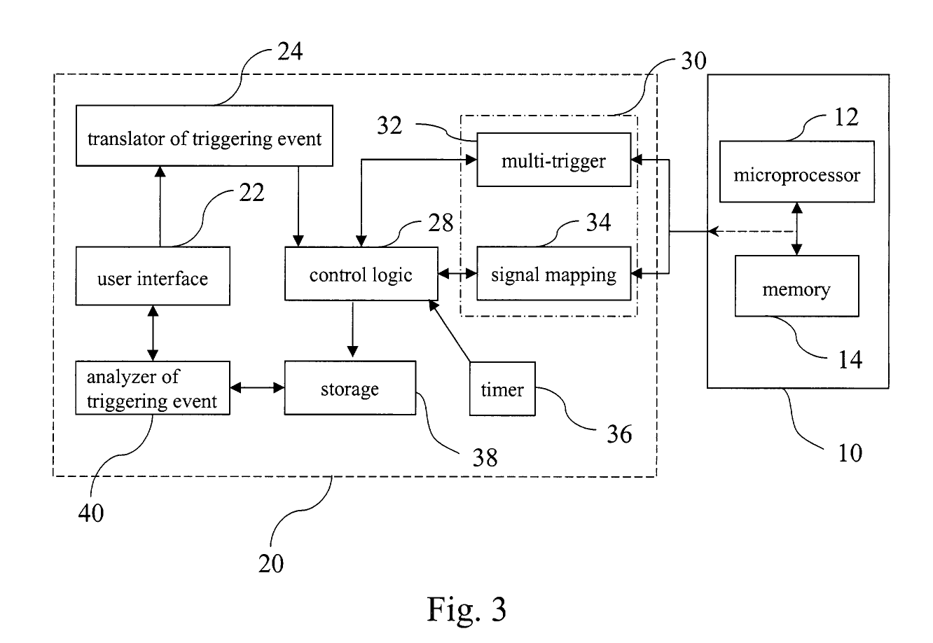

Referring to FIG. 3, which is a block diagram of the debugging device according to the third embodiment of the present invention;

In the above two embodiments, the interface 26 is used to integrate two modules together for transmission of data. However, all of the modules can also be directly integrated together without the interface 26 according to the spirit of the present invention. As shown in FIG. 3, the control logic 28 is directly connected to the translator of triggering event 24. The translator of triggering event 24 directly transfers the triggering event to the control logic 28 after logical simplification. The control logic 28 can directly store all received messages and timing information into the storage 38. The analyzer of triggering events 40 can directly retrieve and restore data from the storage 38 for the user to debug and analyze. Other detailed illustrations are similar to the first embodiment shown in FIG. 1 and thus will not be further described.

In the preferred embodiments, some parts having higher speed requirements, for example, the multi-trigger 32 and the signal mapping 34 of the programmable comparator 30, can be directly built in an IC of the target system. Besides, an analog to digital converter (ADC) may be added at the front end of the programmable comparator 30 so as to record all transmitted signals that are too high or too low in level. This feature could also help the user to further analyze, debug, and solve the problem.

In addition to the single triggering condition, multiple triggering conditions can also be set to trigger the debugging device. First, triggering events 1˜N are set using the programmable comparator 30. When the input signal causes the events 1 to N to occur in order, a triggering occurs. Thereby, a specific event pattern can be immediately recorded without the need of post analysis, hence being very suitable for debugging serial interfaces. Moreover, many sets of triggering event patterns can be set, and the user interface 22 can be used for editing state transitions.

The debugging device of the present invention transforms the information such as addresses, data, and I/Os into a list of codes or indexes to be reviewed, edited and set by users. If the conditions are triggered during operation of the target system, the required recording capacity and transmission bandwidth can be greatly reduced through the corresponding codes or indexes. According to the present invention, the user can filter undesired information and focus on desired information by setting triggering conditions. In addition, by using codes and indexes to indicate the addresses, data, and I/Os, a large quantity of information can be recorded efficiently without taking up much storage space. If each subroutine includes an average of 100 micro instructions and it is necessary to record only one of the 100 instructions, the processing speed of recording is only about 1/100, and the quantity of recorded data is also about 1/100. Moreover, because it is only necessary to record codes of triggering events, the quantity of recorded data can be further reduced. Therefore, the debugging device of the present invention can record and analyze operational states of a target system in real time for a longer period of time in order to analyze system performance and determine the location or range of program bugs according to the recorded information.

Additionally, the present invention can also be utilized to evaluate the performance of the target system without the need of additional signal lines. When evaluating system performance, the debugging device records the timing information of each program and subroutine. So the user can use the timing information to calculate the time duration of all or some certain execution steps, and evaluate the performance of the target system. Therefore, the present invention can debug and determine fault states of a system, and can simultaneously evaluate system performance.

According to the spirit of the present invention, the disclosure can be used in different applications. For example, when an external device connected to a target system issues a command to an IC on the circuit board of the target system, the command is stored into a register in the IC. The triggering signal can be set as the corresponding data/address written in the register. Thereby, it can be known whether the IC is set as or set into an error state. The present invention can also be used in multimedia applications such as DVD players or MPEG decoders. When the debugging device issues an ATAPI command to a servo, all ATAPI commands can be triggered. Thereby, whether there is any incorrect command or whether the order of commands is wrong can be easily observed. Additionally, a timer is located at an input of the programmable comparator. Whether there is a lock, conflict, or collision error generated in some device or on a device bus can be judged utilizing the timing information and time duration of each operational step.

Although the present invention has been described with reference to the preferred embodiments thereof, it will be understood that the invention is not limited to the details thereof Various substitutions and modifications have been suggested in the foregoing description, and other will occur to those of ordinary skill in the art. Therefore, all such substitutions and modifications are intended to be embraced within the scope of the invention as defined in the appended claims.

What is claimed:

1. A debugging device connected to a target system to collect information of said target system for analysis and debugging, said debugging device comprising:
a control logic for outputting simplified data of a triggering event to be recorded;
a programmable comparator connected to the target system for receiving an input signal of the target system, the control logic sets the simplified data into the programmable comparator, the programmable comparator checks whether the input signal conforms to previously set data and passes a corresponding code of the input data to the control logic when a matching condition occurs;
a storage for storing the corresponding code passed from the programmable comparator to the control logic; and
an analyzer capable of retrieving and restoring the corresponding code from the storage into a previously set triggering event.

2. The debugging device as claimed in claim 1, wherein the programmable comparator comprises a multi-trigger and a signal mapping, wherein the multi-trigger generates a signal when a matching condition to the control logic occurs, and the signal mapping outputs a corresponding code of the triggering event.

3. The debugging device as claimed in claim 1, wherein the condition for setting data is recorded in a list of signals to be analyzed, the signals comprising addresses, data, or I/O's.

4. The debugging device as claimed in claim 2, wherein the condition for setting data is recorded in a list of signals to be analyzed, the signals comprising addresses, data, and I/O's.

5. The debugging device as claimed in claim 1, wherein the control logic is further connected to a timer for providing an occurrence time of the control logic triggering event.

6. The debugging device as claimed in claim 1, wherein the programmable comparator is directly built in an integrated circuit, when the device has a higher speed requirement

7. The debugging device as claimed in claim 1, wherein the triggering event comprises a multiple trigger, the multiple trigger events 1˜N are set in advance, and a real trigger occurs when said input signal causes said events 1˜N to occur in order.

8. The debugging device as claimed in claim 7, wherein the multiple triggering setting is accomplished by the programmable comparator.

9. The debugging device as claimed in claim 1, wherein the timer is set as an input of the programmable comparator, and whether there is any collision or error is judged utilizing a length of time of the input signal.

10. The debugging device as claimed in claim 5, wherein the timer is set as one input of the programmable comparator, and whether there is any collision or error is judged utilizing the length of time of the input signal.

11. The debugging device as claimed in claim 1, wherein an analog to digital converter is further disposed at a front end of the programmable comparator.

12. The debugging device as claimed in claim 1 further comprising:
a user interface used to set data for a triggering event to be recorded; and
a translator used to receive data of the triggering event sent out from the user interface, assign a code to the triggering event, and perform logic simplification of the code.

13. The debugging device as claimed in claim 12, wherein an interface is further disposed between the control logic and the translator for utilization of data transmitted between them.

14. The debugging device as claimed in claim 1, wherein access of data in the storage can also be performed through the interface.

15. The debugging device as claimed in claim 13, wherein access of data in the storage can also be performed through the interface.
